(19) United States
(12) Patent Application Publication
(10) Pub. No.: US 2023/0278148 A1
(43) Pub. Date: Sep. 7, 2023

(54) PORTABLE JOBSITE SKID SYSTEM

(71) Applicant: Airgas, Inc., Radnor, PA (US)

(72) Inventor: Stephen BILGER, Houston, TX (US)

(21) Appl. No.: 17/683,548

(22) Filed: Mar. 1, 2022

(51) Int. Cl. B23K 37/02; B23K 35/38

(52) U.S. Cl. CPC B23K 37/0294; B23K 35/383; B23K 37/0241; B23K 37/0258

(57) ABSTRACT

A portable jobsite skid system, including a skid-mounted enclosure made of formed sheet and structural metal, comprising a roof, side panels, and two doors, a first microbulk vessel containing a first pressurized gas, and a second microbulk vessel containing a second pressurized gas, a gas mixer configured to mix the first pressurized gas and the second pressurized gas, and quick disconnect ports configured to connect a gas mixture to the end user. The system may include between two and four doors. The system may include at least one self-contained welding machine, and a means for providing the pressurized gas to the self-contained welding machine.

### BACKGROUND

Transporting and utilizing pressurized gases in the field for cutting, welding, etc. may be logistically challenging. There is a need in the industry for self-contained skids that are easily transported, self-sufficient, and provide the utilities needed at the jobsite.

### SUMMARY

A portable jobsite skid system, including a skid-mounted enclosure made of formed sheet and structural metal, comprising a roof, side panels, and two doors, a first microbulk vessel containing a first pressurized gas, and a second microbulk vessel containing a second pressurized gas, a gas mixer configured to mix the first pressurized gas and the second pressurized gas, and quick disconnect ports configured to connect a gas mixture to the end user. The system may include between two and four doors. The system may include at least one self-contained welding machine, and a means for providing the pressurized gas to the self-contained welding machine.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1a is a schematic representation of the top, left side, right side, and front view of an empty skid, in accordance with one embodiment of the present invention.

FIG. 1b is a schematic representation of the top, left side, right side, and front view of a skid showing the first and second doors, in accordance with one embodiment of the present invention.

FIG. 2a is a schematic representation of the top, left side, right side, and front view of a skid with representative equipment installed, in accordance with one embodiment of the present invention.

FIG. 2b is a schematic representation of the top, left side, right side, and front view of a skid with representative equipment and a firewall installed, in accordance with one embodiment of the present invention.

FIG. 2c is a schematic representation of the top, left side, right side, and front view of a skid with a single pressurized gas vessel and the associated hardware, in accordance with one embodiment of the present invention.

FIG. 3 is a schematic representation of the top, left side, right side, and front view of a skid with lifting lugs and solar panels, in accordance with one embodiment of the present invention.

FIG. 4 is a schematic representation of the top, left side, right side, and front view of a skid with external vaporizers, in accordance with one embodiment of the present invention.

FIG. 5 is a schematic representation of the top, left side, right side, and front view of a skid with lifting lugs and a removable spreader bar roof, in accordance with one embodiment of the present invention.

FIG. 6 is an isometric view of a skid with representative equipment installed, in accordance with one embodiment of the present invention.

FIG. 7 is a schematic representation of multiple views of the door and center beam components of the locking latch, in accordance with one embodiment of the present invention.

FIG. 8a is a schematic representation of a view of the bolt and handle components of the locking latch, in accordance with one embodiment of the present invention.

FIG. 8b is a schematic representation of a view of the bolt and handle components of the locking latch, in accordance with one embodiment of the present invention.

FIG. 8c is a schematic representation of a view of the bolt and handle components of the locking latch, in accordance with one embodiment of the present invention.

FIG. 9a is a schematic representation of the operation of the locking latch, in accordance with one embodiment of the present invention.

FIG. 9b is a schematic representation of the operation of the locking latch, in accordance with one embodiment of the present invention.

FIG. 9c is a schematic representation of the operation of the locking latch, in accordance with one embodiment of the present invention.

FIG. 9d is a schematic representation of the operation of the locking latch, in accordance with one embodiment of the present invention.

FIG. 10a is a schematic representation of the operation of the locking latch, in accordance with one embodiment of the present invention.

FIG. 10b is a schematic representation of the operation of the locking latch, in accordance with one embodiment of the present invention.

### ELEMENT NUMBERS

100 = jobsite skid
101 = front side (of jobsite skid)
102 = back side (of jobsite skid)
103 = left side (of jobsite skid)
104 = right side (of jobsite skid)
105 = top side (of jobsite skid)
106 = bottom side (of jobsite skid)
107 = forklift openings (of jobsite skid)
108 = first door (of jobsite skid)
109 = second door (of jobsite skid)
110 = center beam (of jobsite skid)
201 = first gas vessel
202 = second gas vessel
203 = gas mixer
204 = telemetry unit
205 = gas lines (from gas mixer)
206 = quick disconnect ports
207 = firewall
208 = welding equipment
301 = lifting lugs
302 = solar panels
401 = external vaporizers
501 = removable spreader bar roof
701 = left side locking frame
702 = right side locking frame
703 = left side locking hole
704 = right side locking hole
705 = center beam locking slot
800 = locking latch
801 = locking bolt
802 = left end of locking bolt
803 = right end of locking bolt
804 = locking handle
805 = left side locking bolt spring
806 = right side locking bolt spring

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

The skid has been designed in such a way to make it easily configured to fit the embodiments listed below. For example, mounts have been added for the optional shelving. Ramps may be added to facilitate cylinder movement in and out of the skid.

It will of course be appreciated that in the development of any such actual embodiment, numerous implementation-specific decisions must be made to achieve the developer’s specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

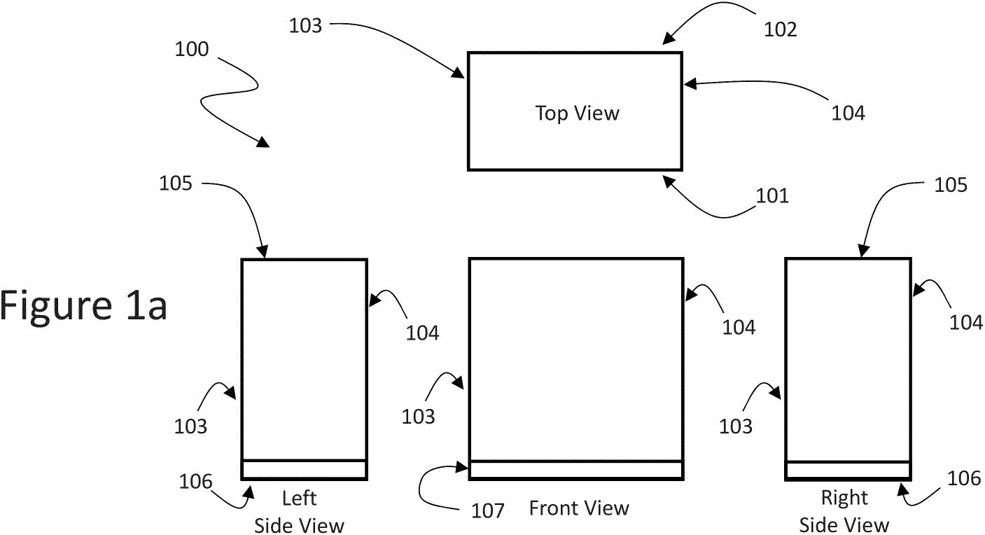

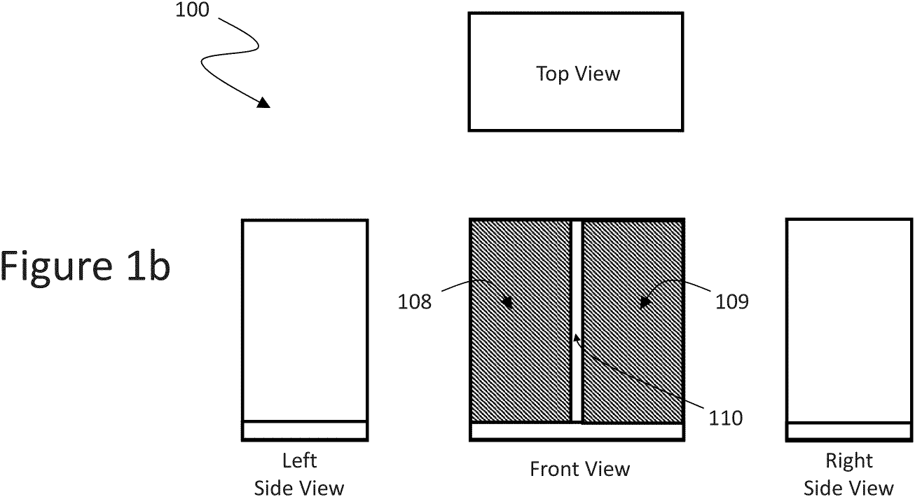

The following view convention (which is clearly identified in FIG. 1a) is also used in FIGS. 1a, 1b, 2a, 2b, 2c, 3, 4, and 5 below. The uppermost figure in each set is the plan view, or the top view. The center figure is the front view (as viewed from the front). The leftmost of the lower figures is the left side view (as viewed from the front). The rightmost of the lower figures is the right-side view (as viewed from the front).

Turning to FIGS. 1a and 1b, jobsite skid 100 is a skid-mounted enclosure formed of sheet and structural metal. The enclosure has front side 101, back side 102, left side (as viewed from the front) 103, and right side 104. The enclosure has top side 105 and bottom side 106. Bottom side 106 may include forklift openings 107. Front side 101 may include first door 108, second door 109, and center beam 110. The back side of jobsite skid 100 may be configured like the front side, or just panelized with no doors.

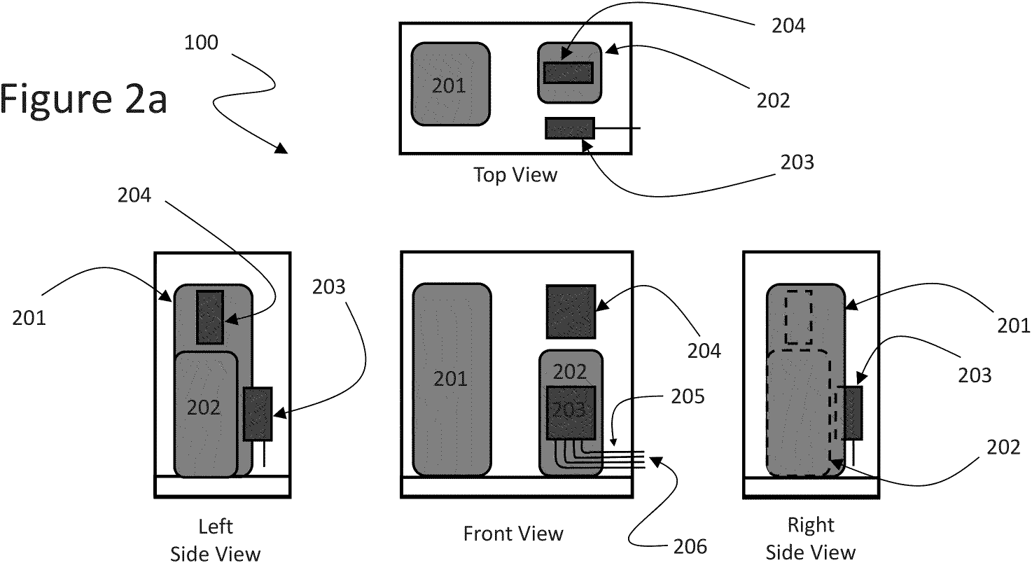

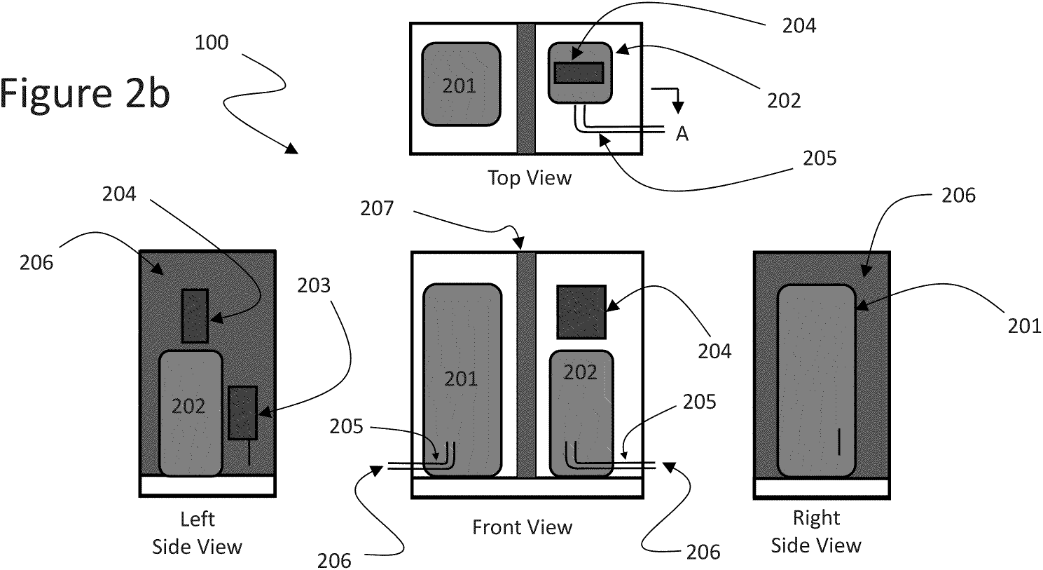

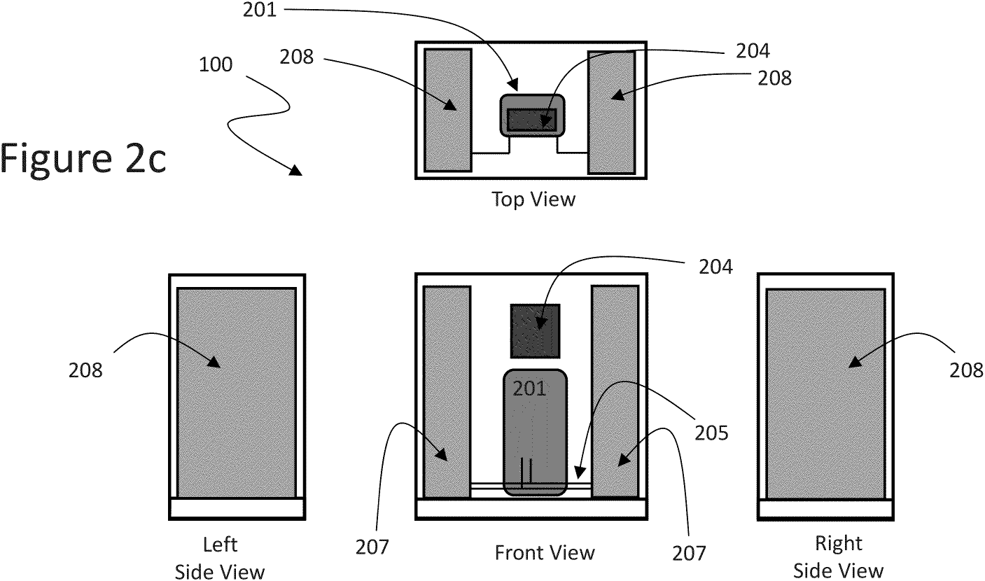

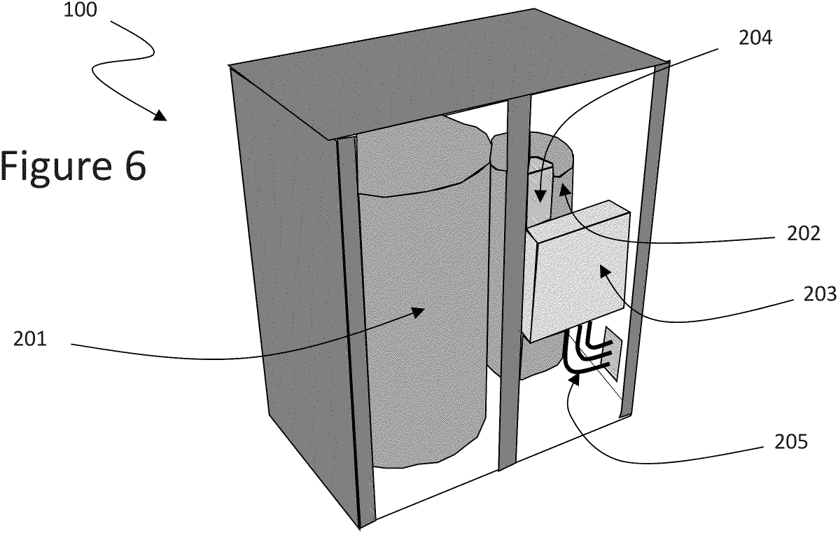

FIGS. 2a, 2b, and 2c are schematic representations of various non-limiting embodiments of the present invention. Turning to FIG. 2a and FIG. 6, one embodiment includes two pressurized gas vessels and the associated hardware. Jobsite skid 100 includes first gas vessel 201, second gas vessel 202, gas mixer 203, telemetry unit 204, and quick disconnect ports. 206.

In one embodiment, first gas vessel 201 contains pressurized argon, and second gas vessel 202 contains pressurized carbon dioxide. In one embodiment, first gas vessel 201 contains pressurized nitrogen, and second gas vessel 202 contains pressurized carbon dioxide. In one embodiment, first gas vessel 201 contains pressurized nitrogen, and second gas vessel 202 contains pressurized hydrogen. In one embodiment, first gas vessel 201 contains pressurized argon, and second gas vessel 202 contains pressurized hydrogen. In one embodiment, first gas vessel 201 contains pressurized argon, and second gas vessel 202 contains pressurized oxygen. In one embodiment, first gas vessel 201 contains pressurized argon, and second gas vessel 202 contains pressurized nitrogen. In one embodiment, first gas vessel 201 contains pressurized argon, and second gas vessel 202 contains pressurized helium. One of ordinary skill in the art will recognize that first gas vessel 201 and second gas vessel 202 may contain any available pressurized gases for which a controlled mixture is desired in the field.

The user may provide an input of a desired gas blend into gas mixer 203, which is fluidically connected to first vessel 201 and second vessel 202. The resulting blended gas mixture is introduced into gas lines 205, which exit the enclosure and are terminated with quick disconnect ports 206. In some embodiments, a blend of gases as well as a pure gas stream exit the system into quick disconnect ports 206. In one embodiment, a blend of gases and a pure argon stream exit the system into quick disconnect ports 206. The user attaches to quick disconnect ports 206, thereby providing shielding gas to his welding equipment. In other embodiments, the various mixtures may be used in applications such as metal heat treatment, leak checking, modified atmosphere packaging (MAP) for food, etc. Telemetry unit 204 provides operation data such as, but not limited to, GPS location, shock monitoring by means of accelerometer, and the amount of gas present in one or both vessels to an operations and maintenance center. In other embodiments, telemetry unit 204 may be used for tank level for automatic reordering of product, flow monitoring (with associated flow meters) for gas allocation, and operational efficiency tracking.

Turning to FIG. 2b, another embodiment includes at least two pressurized gas vessels and the associated hardware. In some embodiments multiple fuel gas vessels are located on the same side of firewall 207. Jobsite skid 100 includes first gas vessel 201, second gas vessel 202, firewall 207, telemetry unit 204, and may include quick disconnect ports. 206. In some embodiments, the fuel gas side of Jobsite skid 100 may simply be used for storage. In one embodiment, first gas vessel 201 contains pressurized fuel gas, and second gas vessel 202 contains pressurized oxygen.

Gas lines 205, which are fluidically connected to first vessel 201 and second vessel 202, which do not mix (and therefore no mixer is present in this embodiment) and exit the enclosure and are terminated with quick disconnect ports 206. The user attaches to quick disconnect ports 206, thereby providing oxygen and fuel to his field equipment. Firewall 207 is a safety precaution that separates the fuel from the oxidant. Telemetry unit 204 provides operation data such as, but not limited to, GPS location, shock monitoring by means of accelerometer, and the amount of gas present in one or both vessels to an operations and maintenance center. In other embodiments, telemetry unit 204 may be used for tank level for automatic reordering of product, flow monitoring (with associated flow meters) for gas allocation, and operational efficiency tracking.

Turning to FIG. 2c, another embodiment includes a single pressurized gas vessel and the associated hardware. Jobsite skid 100 includes gas vessel 201, telemetry unit 204, and welding equipment 208, which may include, but not be limited to, welding power supplies, wire feeders, and associated hoses and cables. ln one embodiment, gas vessel 201 contains pressurized carbon dioxide.

Gas from gas vessel 201 is introduced into gas lines 205, which thereby provide shielding gas to welding equipment 208. Telemetry unit 204 provides operation data such as, but not limited to, GPS location, shock monitoring by means of accelerometer, and the amount of gas present in one or both vessels to an operations and maintenance center. In other embodiments, telemetry unit 204 may be used for tank level for automatic reordering of product, flow monitoring (with associated flow meters) for gas allocation, and operational efficiency tracking.

This embodiment may also include shelving if desired. Gas vessel 201 may be microbulk tanks or pressurized gas cylinders. The microbulk tanks or pressurized gas cylinders may be Individual or may be manifolded together. Two banks of cylinders may be connected with an automatic switchover system. Thus, when one bank is drawn empty, the switchover will activate the full bank. This switchover may be monitored by the telemetry unit 204.

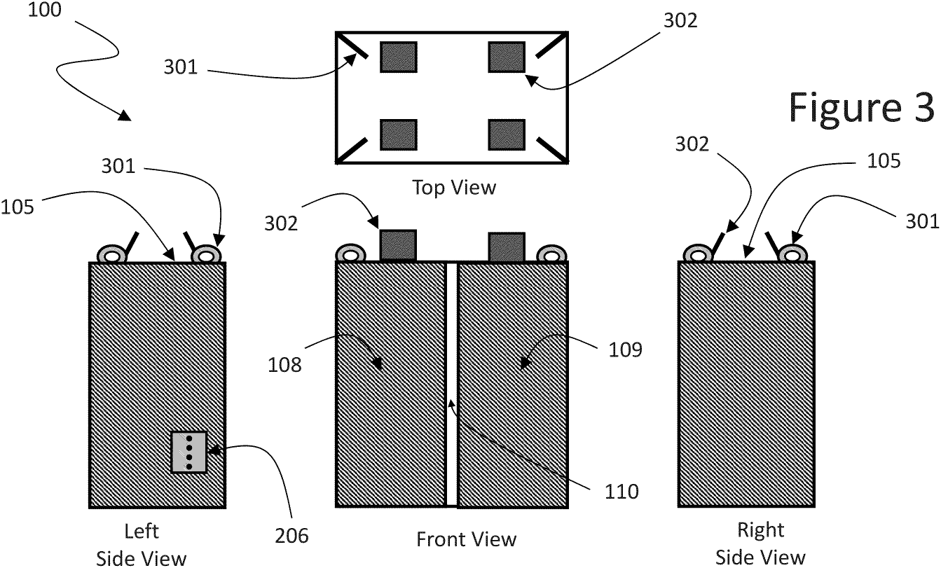

Turning to FIG. 3, another embodiment of jobsite skid 100 is provided. Lifting lugs 301 may be attached to top side 105. Four lifting lugs 301 positioned at the four corners of top side 105 are illustrated but is easy for one of ordinary skill in the art to determine if a different number, placed in different locations, would best apply to a specific arrangement. Solar panels 302 may be attached to top side 105. Solar panels 302 may be used to provide power to a storage battery (not shown), to gas mixer 203, to telemetry unit 204, to welding equipment 208, or to any other equipment requiring electricity. Power may also be provided by a thermoelectric device, such as a Seebeck module, that is able to generate electricity from the temperature difference between the cryogenic liquid in one or more of the pressurized vessels, and the ambient air. A small gas-powered turbine may also be used to provide electricity.

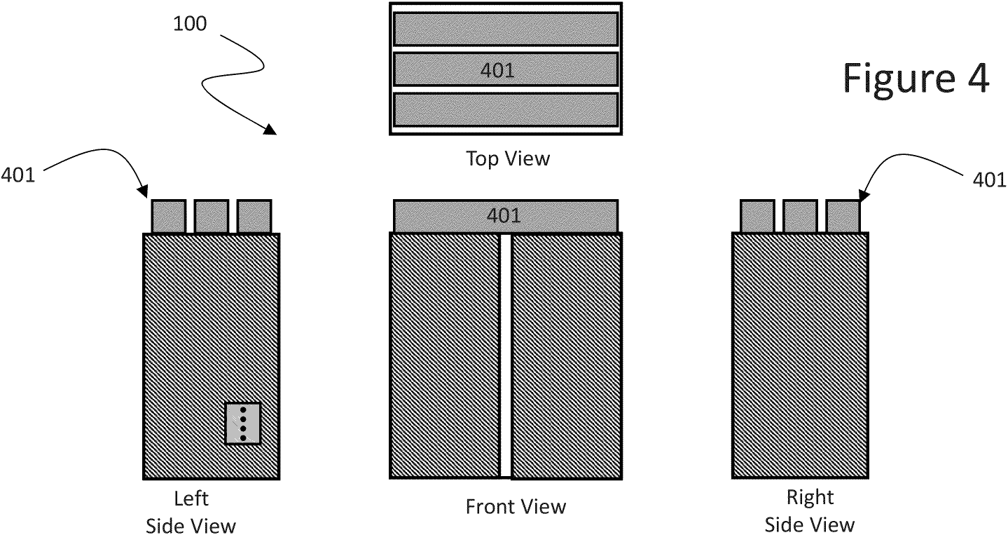

Turning to FIG. 4, another embodiment of jobsite skid 100 is provided. External vaporizers 401 may be attached to top side 105. lf the circumstances require it, external vaporizers 401 may be used to transform the cryogenic fluid from liquid to gaseous form prior to distribution. Three external vaporizers 401 positioned evenly across top side 105 are illustrated but is easy for one of ordinary skill in the art to determine if a different number, placed in different locations, would best apply to a specific arrangement.

External vaporizers 401 may be used to vaporize the gas in first gas vessel 201, the gas in second gas vessel 202, or both vessels as needed. One or more external vaporizers 401 may also be dedicated as pressure building vaporizers to help maintain tank pressure. By placing the vaporizers on top side 1 05 rather than inside jobsite skid 100 allows greater air flow and greater access to direct sunlight, thereby improving their efficiency and simultaneously reducing the footprint of the skid.

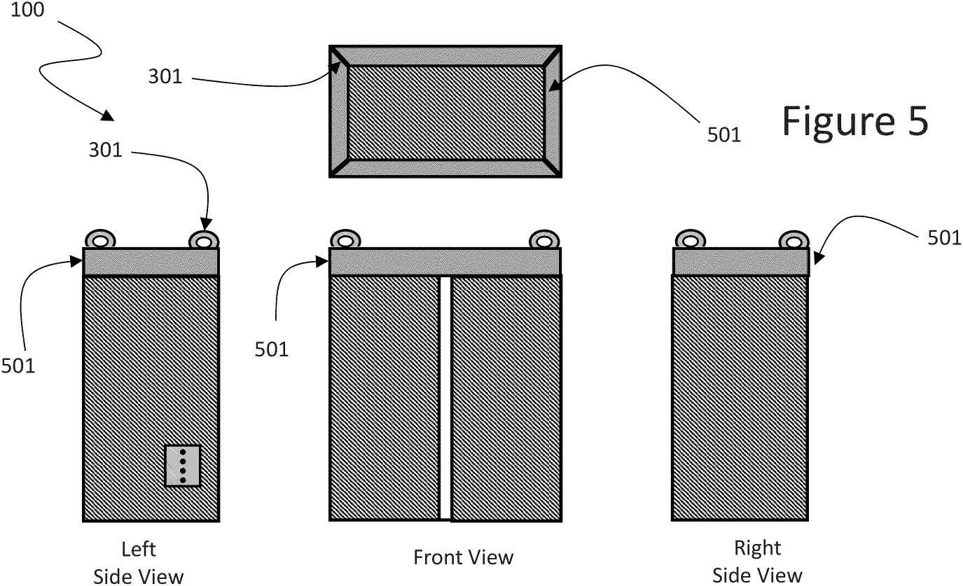

Turning to FIG. 5, another embodiment of jobsite skid 100 is provided. Top side 105 consists of a removable spreader bar 501. Removable spreader bar 501 allows the entire roof to support jobsite skid 100, as well as any roof vaporizers, thereby allowing safer and more effective lifting with a crane on the jobsite. In this configuration the entire roof (including the spreader bar) is removed to facilitate skid assembly, maintenance, or conversion. The roof remains in place when the skid is in operation.

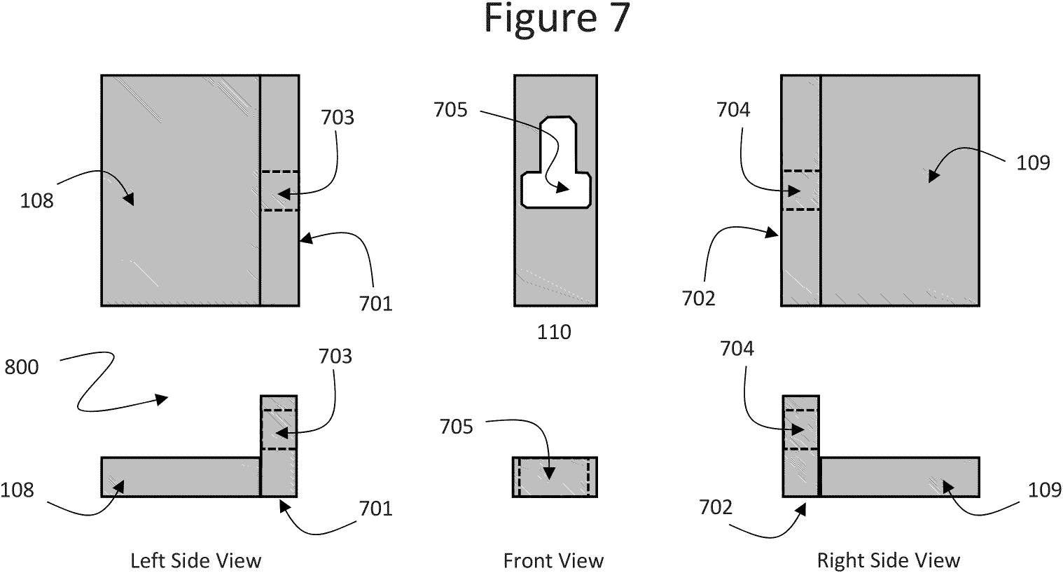

FIGS. 7a, 7b, 7c, 8a, 8b, 8c, 9a, 9b, 10a, and 10b are schematic representations of various non-limiting embodiments of the present invention. Turning to FIGS. 7a, 7b, and 7c, which illustrate the top view, left side view, front view, and right-side view (as viewed from the front), of the door and center beam components of locking latch 800.

First door 108, which is now presumed to be on the left side of jobsite skid 100, has left side locking frame 701, which runs vertically along the rightmost side, i.e. furthest from the hinges and closest to the center the skid. Second door 109, which is now presumed to be on the right side of jobsite skid 100, has right side locking frame 702, which runs vertically along the leftmost side, i.e. furthest from the hinges and closest to the center the skid. Left side locking frame 701 and right-side locking frame 702, when the doors are in the closed position, are proximate to center beam 110.

Left side locking frame 701 has left side locking hole 703 which is configured to accept left end of locking bolt 802 (below). Right side locking frame 702 has right side locking hole 704 which is configured to accept right end of locking bolt 803 (below). Center beam 110 has center beam locking slot 705 which is configured to accept locking handle 804 (below.

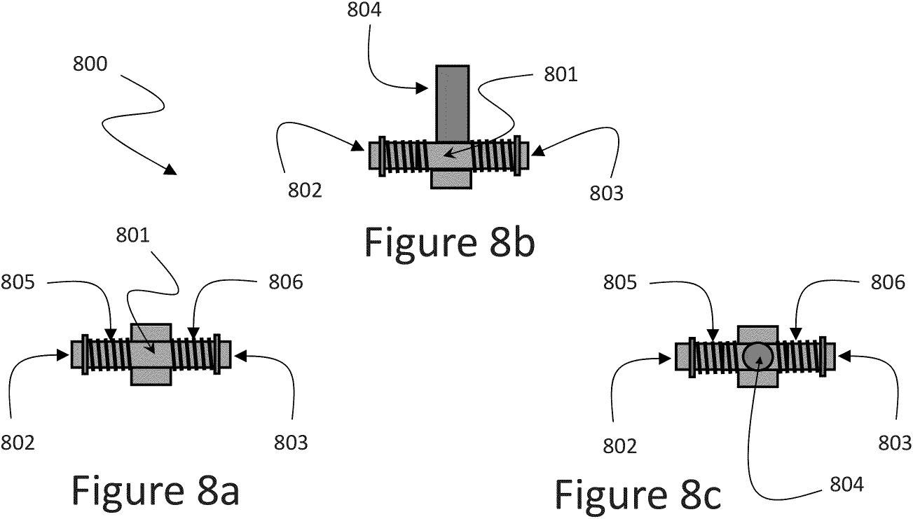

Turning to FIGS. 8a, 8b, and 8c, which illustrate the left side view, front view, and right-side view (as viewed from the back, top, and front respectively), of the bolt and handle components of locking latch 800. Locking bolt 801 comprises a left end 802 and a right end 803. Left end of locking bolt 802 is configured to fit into left side locking hole 703. Right end of locking bolt 803 is configured to fit into right slide locking hole 704. As described below, left side locking bolt spring 805 and right-side locking bolt spring 806 work in unison to keep locking handle 804 in a neutral, unlocked position when access to jobsite skid 100 internals is desired.

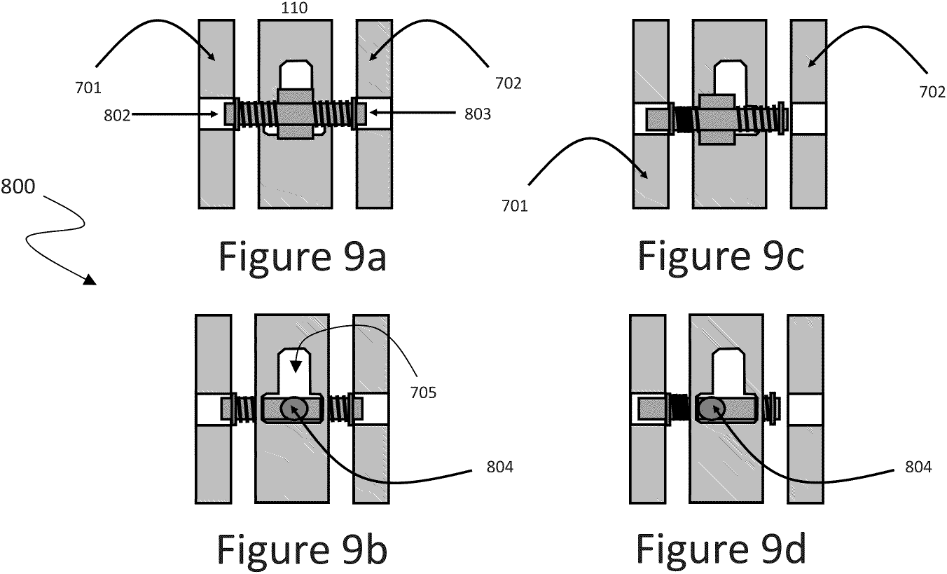

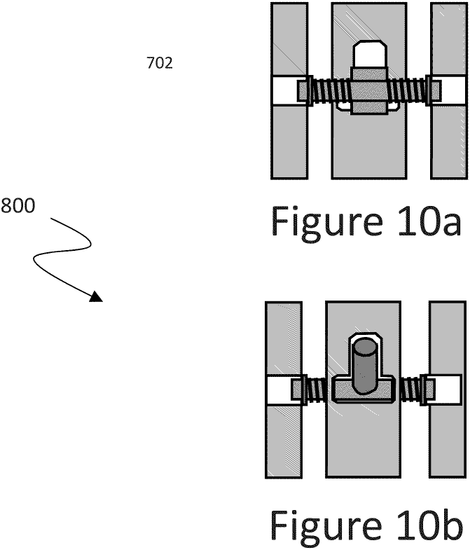

Turning to FIGS. 9a, 9b, 9c, 9d, 10a, and 10b which illustrate the front view of the operation of locking latch 800. The convention used in these figures is that the top figures of each set (i.e. 9a, 9c, and 10a) represent the view one would have from the inside of the skid. The bottom figures of each set (i.e. 9b, 9d, and 10b) represent the view one would have from the outside of the skid.

FIGS. 9a and 9b illustrate the unlocked position with both doors closed. Locking handle 804 is in the center of center beam locking slot 705. Neither left side locking bolt spring 805 nor right side locking bolt spring 806 are compressed. Both springs are somewhat compressed while the locking bolt is in the center position. One spring is more compressed with the locking bolt is moved to its side, while the other spring becomes less compressed. Both left end of locking bolt 802 and right end of locking bolt 803 are engaging left side locking hole 703 and right-side locking hole 704. Consequently, both left side locking frame 701 (and thus first door 108) and right side locking frame 702 (and thus second door 109) are not locked, yet also not free to move unexpectedly. This is an unlocked, but secured position for both doors.

FIGS. 9c and 9d illustrate the unlocked position with first door 108 free to move. Locking handle 804 is left of center of center beam locking slot 705. Left side locking bolt spring 805 is compressed. Left end of locking bolt 802 is engaging left side locking hole 703. However, right end of locking bolt 803 is not engaging right side locking hole 704. Consequently, left side locking frame 701 (and thus first door 108) is not free to move, yet right side locking frame 702 (and thus second door 109) is free to move. This is an unlocked position with only left side door secured. The skilled artisan would recognize that if the positions described herein were reversed, then the second door 109 would be free to move.

FIGS. 10a and 10b illustrate the locked position with both doors closed. Locking handle 804 is in the center of center beam locking slot 705. Neither left side locking bolt spring 805 nor right side locking bolt spring 806 are compressed. Neither spring is fully compressed when the locking bolt is in the center position. Both left end of locking bolt 802 and right end of locking bolt 803 are engaging left side locking hole 703 and right-side locking hole 704. However, in the locked condition, locking handle 804 is tilted upwards in center beam locking slot 705. This restricts the lateral movement of locking handle 804 and maintains the engagement of the locking bolts in both slots. If desired, a padlock or other similar means (not shown) may be utilized to secure locking handle 804 in this locked position Consequently, both left side locking -frame 701 (and thus first door 108) and right-side locking frame 702 (and thus second door 109) are locked and not free to move unexpectedly. This is a locked and secured position for both doors.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A portable jobsite skid system, comprising:
• a skid-mounted enclosure made of formed sheet and structural metal, comprising a roof, side panels, and two doors,
• a first microbulk vessel containing a first pressurized gas, and a second microbulk vessel containing a second pressurized gas,
• a gas mixer configured to mix the first pressurized gas and the second pressurized gas, and
• quick disconnect ports configured to connect a gas mixture to the end user.

2. The portable jobsite skid system of claim 1, wherein the first pressurized gas comprises argon, and the second pressurized gas comprises carbon dioxide.

3. The portable jobsite system of claim 1, further comprising a blended gas output from the mixer, and a pure gas output.

4. The portable jobsite skid system of claim 1, wherein the gas mixer may be removed from the skid-mounted enclosure.

5. The portable jobsite skid system of claim 1, wherein the quick disconnect ports are built into, and integral to, the gas mixer.

6. The portable jobsite skid system of claim 1, further comprising at least one vaporizer mounted on the roof.

7. The portable jobsite skid system of claim 1, further comprising one or more system selected from the group consisting of: at least one retractable and adjustable solar panels mounted on the roof, thermoelectric generator, and a gas-powered generator.

8. The portable jobsite skid system of claim 1, wherein the roof comprises a removable spreader bar frame.

9. The portable jobsite skid system of claim 1, further comprising a spring-loaded door latch configured such that,
• when in a first position, one or both doors will close securely, remain closed, but remain unlocked, and
• when in a second position, both doors will be locked.

10. The portable gas delivery system of claim 1, further comprising a firewall located between the first microbulk vessel and the second microbulk vessel and wherein there is no mixer.

11. A portable jobsite skid system, comprising:
• a skid-mounted enclosure made of formed sheet and structural metal, comprising a roof, and between two and four doors,
• at least one microbulk vessel containing a pressurized gas,
• at least one self-contained welding machine, and
• a means for providing the pressurized gas to the self-contained welding machine.

12. The portable jobsite skid system of claim 11, further comprising a first microbulk vessel containing a first pressurized gas, and a second microbulk vessel containing a second pressurized gas, a mixer configured to mix the first pressurized gas and the second pressurized gas and thus produce a mixed gas, and a means for providing the mixed gas to the self-contained welding machine.

13. The portable jobsite skid system of claim 12, wherein the first pressurized gas and the second pressurized gas are selected from the group consisting of: nitrogen and carbon dioxide, nitrogen and hydrogen, argon and hydrogen, argon and oxygen, and nitrogen and argon.

14. The portable jobsite skid system of claim 12, wherein the mixer comprises a gas mixer configured to provide two different predetermined gas mixtures simultaneously.

15. The portable jobsite skid system of claim 12, wherein the mixer comprises a gas mixer configured to provide three different predetermined gas mixtures simultaneously.

16. The portable jobsite skid system of claim 12, wherein the gas mixer may be removed from the skid-mounted enclosure.

17. The portable jobsite skid system of claim 11, further comprising at least one vaporizer mounted on the roof.

18. The portable jobsite skid system of claim 11, further comprising at least one retractable and adjustable solar panels mounted on the roof.

19. The portable jobsite skid system of claim 11, wherein the roof comprises a removable spreader bar frame.

20. The portable jobsite skid system of claim 11, further comprising a spring-loaded door latch configured such that,
• when in a first position, one or both doors will close securely, remain closed, but remain unlocked, and
• when in a second position, both doors will be locked.
